(19) United States
(12) Patent Application Publication
(10) Pub. No.: US 2026/0124806 A1
(43) Pub. Date: May 7, 2026

(54) Recycling and Additive Manufacturing Apparatus

(71) Applicant: Michelle Burke, Anchorage, AK (US)

(72) Inventor: Michelle Burke, Anchorage, AK (US)

(21) Appl. No.: 19/378,390

(22) Filed: Nov. 4, 2025

Related U.S. Application Data
(60) Provisional application No. 63/715,894, filed on Nov. 4, 2024.

(51) Int. Cl. B29C 64/357; B29C 64/118; B29C 64/25; B29C 64/393; B33Y 10/00; B33Y 30/00; B33Y 40/00; B33Y 40/10; B33Y 50/02

(52) U.S. Cl. CPC B29C 64/357; B29C 64/118; B29C 64/25; B29C 64/393; B33Y 10/00; B33Y 30/00; B33Y 40/00; B33Y 40/10; B33Y 50/02

(57) ABSTRACT

A self-contained recycling and additive manufacturing apparatus that transforms discarded polymeric waste into new three-dimensional (3D) printed objects. The apparatus includes a housing containing a waste intake and sorting assembly with a receptacle bin, shredder, and separator for preprocessing recyclable materials. A grinding and melting subsystem mechanically reduces and thermally melts the sorted waste, and an extruder converts the molten polymer into continuous filament for 3D printing. A digital control interface featuring a display panel, selectable 3D model options, and status indicator lights enables intuitive operation and real-time monitoring. A printing chamber enclosed by a transparent pivotable lid houses a movable build platform and print head assembly for layer-by-layer fabrication. The system is powered by a rechargeable battery, enabling portable and off-grid operation.

### CROSS-REFERENCE TO RELATED APPLICATION

The present application claims priority to, and the benefit of, U.S. Provisional Application No. 63/715,894 which was filed on Nov. 4, 2024 and is incorporated herein by reference in its entirety.

### FIELD OF THE INVENTION

The present invention generally relates to recycling systems and additive manufacturing devices. More specifically, the present invention relates to a self-contained recycling and additive manufacturing apparatus configured to convert polymeric materials into new three-dimensional (3D) printed objects. The apparatus includes a housing that defines a structural framework that supports a waste intake and sorting assembly, a grinding and melting subsystem, and a 3D printing assembly. The waste intake and sorting assembly includes a receptacle bin for collecting recyclable materials and a foot-actuated pedal that enables hands-free operation. The grinding and melting subsystem incorporates a grinder, a heater, and an extruder, configured to process polymeric waste into molten plastic and form a continuous filament suitable for printing. A pivotable transparent lid covers the printing chamber, enabling user visibility during operation. A digital control interface featuring a display panel, model selection options, and operational status indicators provides comprehensive user control. Accordingly, the present disclosure makes specific reference thereto. Nonetheless, it is to be appreciated that aspects of the present invention are also equally applicable to other like applications, devices, and methods of manufacture.

### BACKGROUND

By way of background, recycling of material is important but a challenging component of modern waste management. Although numerous types of plastics and polymers are technically recyclable, the process of collecting, sorting, transporting and reprocessing such materials is expensive, labor-intensive, and energy-consuming. As a result, large volumes of recyclable materials are often discarded as general waste, ultimately ending up in landfills or incineration facilities, contributing to environmental degradation and resource depletion. This inefficiency undermines the environmental benefits that recycling systems are designed to achieve and highlights the need for localized, cost-effective recycling solutions.

Furthermore, traditional recycling infrastructure typically operates at an industrial scale, requiring centralized facilities and extensive logistics chains. The conventional model limits accessibility for individual consumers and small-scale users who wish to participate in material recovery and reuse. Consequently, even when recyclable materials such as plastic bottles, containers, and packaging are collected, they are frequently underutilized or improperly processed, leading to the unnecessary consumption of new raw materials for manufacturing.

At the same time, the field of additive manufacturing, commonly known as 3D printing, has experienced rapid growth across consumer and industrial sectors. However, the filament materials used for 3D printing including commonly used thermoplastics such as PLA, ABS, and PETG, remain relatively expensive to produce and purchase. The expensive costs limit the accessibility of 3D printing technology for everyday users, educators, and small enterprises. Accordingly, individuals desire a self-contained, user-friendly apparatus capable of recycling household or small-scale plastic waste directly into usable 3D printing filament.

Therefore, there exists a long-felt need in the art for an improved, cost-effective, and sustainable method of recycling polymeric materials and repurposing them for manufacturing use. There is a need for a compact, automated, and self-contained system capable of converting discarded plastic waste directly into usable 3D printing filament. Furthermore, there exists a need for a system that makes recycling easy for users at personal level. Additionally, there is a need for a compact system that makes recycling items easy, effective, and convenient. Finally, there is a need for a system that eliminates the need for external recycling infrastructure and reduces dependence on costly, virgin 3D printing materials.

The subject canter disclosed and claimed herein, in one embodiment, comprises a self-contained recycling and additive manufacturing apparatus designed to transform discarded polymeric materials into new 3D printed objects. The apparatus integrates subsystems including a waste intake and sorting assembly, a grinding and melting subsystem, and a 3D printing assembly. The waste intake assembly receives and classifies recyclable materials, the grinding and melting subsystem mechanically and thermally processes the material into a homogeneous molten polymer, and an extrusion mechanism converts the molten material into a continuous filament. A digital control interface positioned on the housing enables user input, monitoring, and model selection through a touchscreen display featuring operational indicators and status LEDs. The apparatus comprises a pivotable transparent lid covering the printing chamber, enabling the user to observe the printing process and remove finished objects safely.

In one embodiment, the apparatus includes a rechargeable battery disposed within the housing to enable portable and off-grid operation. The battery supplies electrical power to the grinding, melting, extrusion, and printing subsystems, as well as the electronic control interface. The waste intake assembly comprises a foot-actuated pedal for hands-free access to a sliding receptacle bin, facilitating the hygienic collection of waste material.

In this manner, the self-contained recycling and additive manufacturing apparatus of the present invention overcomes the long-standing deficiencies in conventional recycling and 3D printing technologies. The invention provides an integrated, user-friendly, and environmentally sustainable solution that empowers individuals to recycle their own plastic waste into functional and decorative 3D printed items. By combining material recovery, filament production, and additive manufacturing in a single compact unit, the system eliminates the need for external recycling infrastructure and reduces dependence on costly, virgin 3D printing materials. The apparatus reduces landfill waste and makes sustainable personal manufacturing accessible to a broader range of users.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject canter disclosed and claimed herein, in one embodiment thereof, comprises a self-contained recycling and additive manufacturing apparatus configured to automatically transform discarded polymeric materials into new three-dimensional printed objects. The apparatus comprises a housing having a top end and a base, a waste intake and sorting assembly designed to receive, sort, and temporarily store recyclable waste, and a grinding and melting subsystem connected thereto. The subsystem reduces the waste material into particulate form, melts it into a homogeneous molten polymer, and extrudes it into a continuous filament. A digital control interface with a graphical display and indicator lights enables user input and system monitoring. The upper portion of the housing includes a printing chamber with a movable build platform, a filament spool, and a print head assembly supported by a gantry for three-dimensional motion, thereby enabling on-demand additive manufacturing using the recycled filament.

In another embodiment, the invention provides a recycling and 3D printing apparatus integrating a shredder, a separator, a grinding and melting unit, an extrusion mechanism, and a printing system within a single housing. The shredder fragments plastic waste into smaller pieces, while the separator segregates materials by polymer type or density. The grinding and melting unit pulverizes and melts the waste, forming a continuous filament through an extrusion mechanism. A digital interface with selectable models and subsystem status indicators enables users to control and monitor all processes. A transparent, pivotable lid encloses the printing chamber for safety and visibility, and the entire system is powered by an internal rechargeable battery to enable portable and off-grid operation.

In yet another embodiment, a method for producing a three-dimensional printed object from recyclable polymeric waste material is described. The method includes detecting a waste item, identifying its polymeric type, and setting an appropriate melting temperature. The waste is ground and melted into a homogeneous molten polymer, which is then extruded into a continuous filament. A user selects a desired 3D model through the digital interface, and the apparatus subsequently performs additive manufacturing by extruding the filament through a print head within an enclosed printing chamber. The method ensures automated detection, adaptive control of temperature, and efficient transformation of waste into new functional or decorative products.

In still another embodiment, the invention provides a digital control interface for use with the recycling and additive manufacturing apparatus. The interface includes a display panel presenting selectable three-dimensional model options and a series of operational status indicator lights corresponding to different subsystems.

In still another embodiment, the invention also provides a portable, battery-powered recycling and additive manufacturing system. The system includes a lightweight, impact-resistant housing containing a removable waste intake bin, a grinding and melting subsystem for filament production, and a 3D printing subsystem including a print head, movable platform, and transparent pivotable lid. A rechargeable battery housed within the system supplies electrical power to all subsystems, including the digital control interface, enabling autonomous operation without a continuous external power source.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a self-contained recycling and additive manufacturing apparatus of the present invention in accordance with the disclosed structure;

FIG. 2 illustrates a schematic block diagram illustrating the internal configuration of the waste intake and sorting assembly of the present invention in accordance with the disclosed structure;

FIG. 3 illustrates a schematic block diagram illustrating the internal configuration of the grinding and melting subsystem of the present invention in accordance with the disclosed structure;

FIG. 4 illustrates a process flow diagram illustrating the operational sequence of the self-contained recycling and additive manufacturing apparatus of the present invention in accordance with the disclosed structure;

FIG. 5 illustrates a front view of the digital control interface used in the apparatus of the present invention in accordance with the disclosed structure;

FIG. 6 illustrates a side perspective view of the self-contained recycling and additive manufacturing apparatus of the present invention in accordance with the disclosed structure; and

FIG. 7 illustrates another process flow diagram illustrating a method of automated operation of the self-contained recycling and additive manufacturing apparatus of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved, cost-effective, and sustainable method of recycling polymeric materials and repurposing them for manufacturing use. There is a need for a compact, automated, and self-contained system capable of converting discarded plastic waste directly into usable 3D printing filament. Furthermore, there exists a need for a system that makes recycling easy for users at personal level. Additionally, there is a need for a compact system that makes recycling items easy, effective, and convenient. Finally, there is a need for a system that eliminates the need for external recycling infrastructure and reduces dependence on costly, virgin 3D printing materials.

The present invention, in one exemplary embodiment, is a method for producing a three-dimensional printed object from recyclable polymeric waste material. The method includes detecting a waste item, identifying its polymeric type, and setting an appropriate melting temperature. The waste is ground and melted into a homogeneous molten polymer, which is then extruded into a continuous filament. A user selects a desired 3D model through the digital interface, and the apparatus subsequently performs additive manufacturing by extruding the filament through a print head within an enclosed printing chamber. The method ensures automated detection, adaptive control of temperature, and efficient transformation of waste into new functional or decorative products.

Reference will now be made in detail to the present preferred embodiments of the invention, examples of which are illustrated in the accompanying drawings. Wherever possible, the same reference numerals are used in the drawings and the description to refer to the same or like parts.

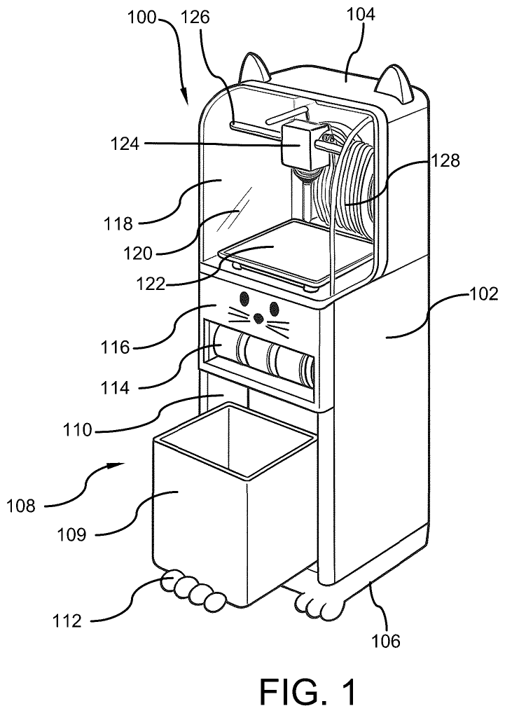

Referring initially to the drawings, FIG. 1 illustrates a perspective view of a self-contained recycling and additive manufacturing apparatus of the present invention in accordance with the disclosed structure. The self-contained recycling and additive manufacturing apparatus 100 of the present invention is designed to automatically transform discarded plastic items into new items. The apparatus 100 is configured to bridge the gap between waste management and personal manufacturing, enabling users to recycle their own plastics into printable filament for custom 3D objects.

The apparatus 100 includes a durable housing 102 extending between a top end 104 and a base 106. The base 106 supports the apparatus 100 and provides structural stability to the housing 102. A waste intake and sorting assembly 108 is configured to receive, sort, and temporarily store recyclable polymeric waste material. The waste intake and sorting assembly 108 includes a receptacle bin 109 which is slidably mounted in the bottom portion 110 of the housing 102 and further, includes a user-actuated access foot pedal 112 for hands-free operation.

A grinding and melting subsystem 114 is operatively connected to the waste intake and sorting assembly 108. The grinding and melting subsystem 114 is configured to mechanically reduce the recyclable polymeric waste material into particulate form and subsequently apply controlled thermal energy to melt the particulate material into a homogeneous molten polymer.

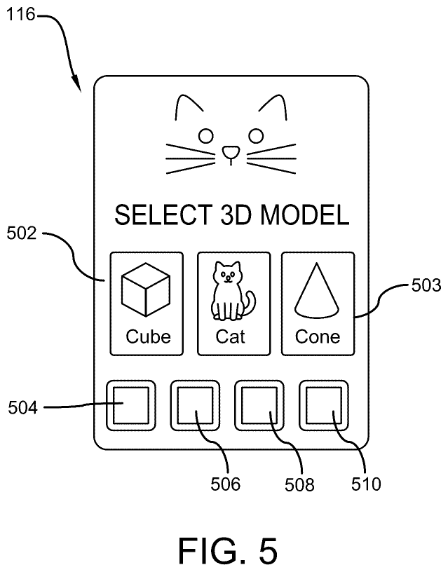

The housing 102 includes a control interface section 116 in the form of an interactive display panel stylized preferably as a cat face and is configured to provide user input, status indication, and operational control of the apparatus 100. The control interface 116 is operatively connected to an internal electronic controller which controls all mechanical and thermal components of the apparatus 100. The control interface 116 comprises a touchscreen liquid-crystal display (LCD) panel integrated with status-indicator lighting to provide user feedback on operational states of the apparatus as described in FIG. 5.

The upper portion of the housing 102 provides an enclosed printing chamber 118 covered by a transparent protective lid 120. Within the chamber 118 is a movable build platform 122 disposed beneath a print head assembly 124 that is supported by a gantry 126 for controlled three-dimensional motion during additive manufacturing operations. A filament spool 128 is positioned within the chamber 118 to supply thermoplastic filament to the extrusion nozzle of the print head 124. The filament spool 128 is operatively connected to the grinding and melting subsystem 114 and is continuously formed from the recyclable polymeric waste material received by the apparatus 100. The gantry 126 provides three-axis motion along orthogonal X, Y, and Z axes using lead screws, linear bearings, and/or stepper motors.

In one preferred embodiment, the housing 102 can be fabricated from a lightweight, impact-resistant polymeric material such as acrylonitrile butadiene styrene (ABS), polycarbonate (PC), or aluminum alloy for improved rigidity and heat dissipation. The housing 102 can have dimensions of about 800 mm to 1000 mm in height, 350 mm to 500 mm in width, and 350 mm to 450 mm in depth.

The receptacle bin 109 of the waste intake and sorting assembly 108 is preferably constructed of high-density polyethylene (HDPE) or stainless steel and is removably mounted to facilitate cleaning and material segregation. The foot pedal 112 comprises a mechanical linkage or electronic actuator configured to automatically open the receptacle bin 109 when depressed.

The grinding and melting subsystem 114 comprises a rotary blade assembly driven by an electric motor operating between 3000 rpm and 6000 rpm to reduce the recyclable polymeric material into flakes. The transparent protective lid 120 can be formed of tinted polycarbonate or acrylic to prevent ultraviolet exposure during printing while enabling visual monitoring.

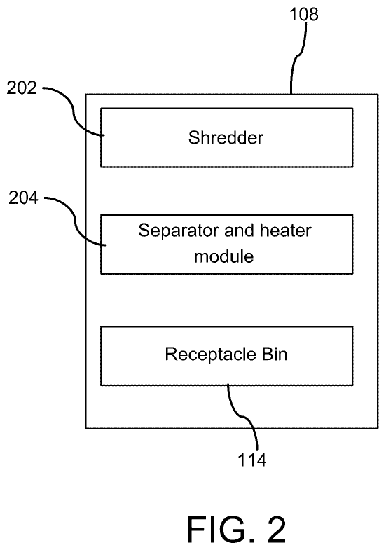

FIG. 2 illustrates a schematic block diagram illustrating the internal configuration of the waste intake and sorting assembly of the present invention in accordance with the disclosed structure. The waste intake and sorting assembly 108 is configured to receive, identify, and preliminarily process recyclable polymeric material before delivery to the grinding and melting subsystem 114 as described in connection with FIG. 1.

The shredder 202 is positioned at an upper portion of the assembly 108 and is configured to mechanically fragment or comminute plastic waste materials into smaller, manageable pieces. In one embodiment, the shredder 202 may employ rotating blades, cutters, or hammers driven by an electric motor to reduce the size of the plastic feedstock. The shredded material is then directed downward toward the separator 204 for further processing.

A separator and heater module 204 is disposed below the shredder 202 and is configured to heat and segregate the shredded plastic based on predefined criteria such as polymer type, color, or density. In some embodiments, the separator 204 may employ mechanical sieving or airflow classification to distinguish between types of recyclable materials.

The receptacle bin 114 is positioned at the lower end of the waste intake and sorting assembly 108 and functions as a collection and storage chamber for the sorted plastic fragments. The bin 114 may be removably or slidably mounted to facilitate emptying, maintenance, and cleaning. During operation, the user deposits plastic waste into the shredder 202, which shreds the material and passes it to the separator 204.

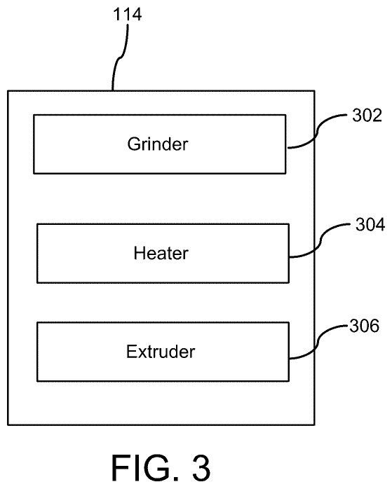

FIG. 3 illustrates a schematic block diagram illustrating the internal configuration of the grinding and melting subsystem of the present invention in accordance with the disclosed structure. The grinding and melting subsystem 114 is configured to convert the processed and sorted recyclable polymeric material, as received from the waste intake and sorting assembly 108, into a usable thermoplastic filament suitable for additive manufacturing operations.

The grinder 302 is configured to mechanically pulverize or further reduce the particle size of the sorted recyclable plastic material. The grinder 302 comprises a rotary blade mechanism, crushing rollers, or abrasion plates designed to achieve a uniform flake size suitable for efficient melting.

A heater 304 is coupled to the grinder 302 and is configured to receive the ground polymeric flakes. The heater 304 provides controlled thermal energy to melt the flakes into a homogeneous molten polymer. The heater 304 may employ a resistive heating element, induction heating coil, or infrared thermal array operating within a temperature range of approximately 180° C. to 260° C. The temperature may be automatically regulated based on the polymer type.

An extruder 306 is operatively connected to the heater 304 and receives the molten polymer for filament formation. The extruder 306 comprises a precision nozzle, extrusion die, and cooling channel configured to form a continuous filament of consistent diameter.

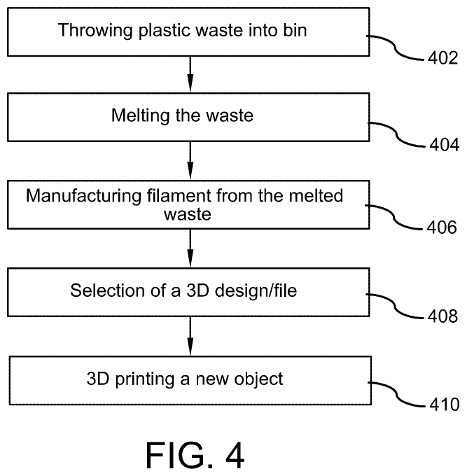

FIG. 4 illustrates a process flow diagram illustrating the operational sequence of the self-contained recycling and additive manufacturing apparatus of the present invention in accordance with the disclosed structure. Initially, plastic waste is thrown into the receptacle bin 109 (Step 402). A user deposits recyclable polymeric materials such as polyethylene terephthalate (PET), high-density polyethylene (HDPE), or polypropylene (PP) into the receptacle bin of the apparatus. The bin may be opened using a foot-actuated pedal, enabling hands-free operation.

At step 404, melting of the waste is initiated after separation. The waste material, after being shredded and sorted, is subjected to thermal processing that converts the solid polymer fragments into a molten state. It should be noted that heating and melting is done in both waste intake and sorting assembly 108 and grinding and melting subsystem 114.

Then, filament from the melted waste is created (Step 406). The molten polymer can be extruded through a precision nozzle or die to form a continuous filament of uniform diameter. The filament is cooled, hardened, and spooled for storage. The filament is used for subsequent additive manufacturing operations.

Thereafter, the user performs selection of a 3D design or file for generating a 3D object (Step 408). Using the digital control interface of the apparatus, the user can select a preloaded design file or upload a custom model. The interface provides multiple categories or preset design options for quick selection.

Finally, the apparatus utilizes the recycled filament as input material for the 3D printing subsystem, which constructs the selected object layer by layer according to the digital design data (Step 410). The resulting printed product comprises functional or decorative items, such as novelty trays, molds, or customized figurines.

FIG. 5 illustrates a front view of the digital control interface used in the apparatus of the present invention in accordance with the disclosed structure. The digital control interface 116 functions as the primary human-machine interaction point of the self-contained recycling and additive manufacturing apparatus 100. The interface 116 enables the user to monitor system operations, select 3D designs for printing, and initiate various stages of the recycling and printing process.

As illustrated in FIG. 5, the digital control interface 116 comprises a display panel 502 which presents a graphical user interface. The display panel 502 includes a section 503 for 3D model selection, enabling a user to choose among various preloaded design options such as a cube, cat, or cone representation. The apparatus 100 can also permit uploading or downloading of additional 3D design files via external communication interfaces such as USB, Wi-Fi, or Bluetooth.

The digital control interface 116 features a series of status indicator LEDs (504, 506, 508, 510), each corresponding to a specific operational subsystem of the apparatus 100. As a non-limiting example, indicator 504 may represent the operational state of the waste intake and sorting assembly 108, illuminating when the unit is active or receiving recyclable material. LED 506 is associated with the grinding and melting subsystem 114, illuminating when thermal processing or filament extrusion is in progress. LED 508 is associated with the digital control interface 116 and LED 510 represents the 3D printing subsystem, activating when the apparatus is engaged in additive manufacturing using the recycled filament.

The LED indicators 504, 506, 508, 510 may emit distinct colors to signify different system states such as standby, processing, or error, thereby providing the user with immediate visual feedback.

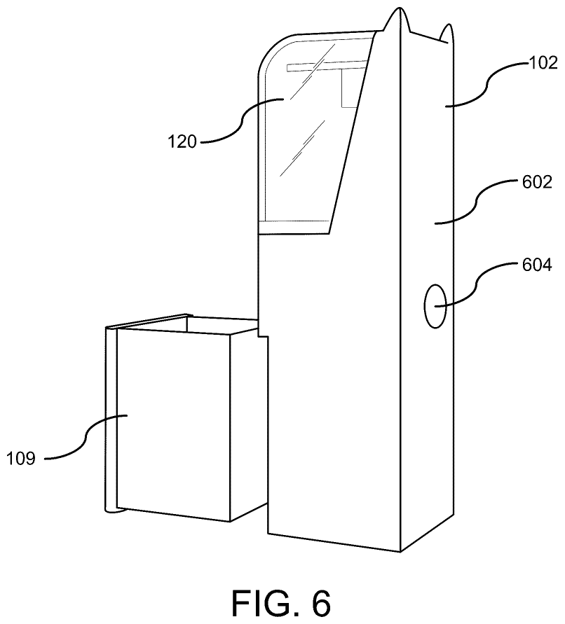

FIG. 6 illustrates a side perspective view of the self-contained recycling and additive manufacturing apparatus of the present invention in accordance with the disclosed structure. The pivotable transparent lid 120 encloses the printing chamber 118 (FIG. 1). The lid 120 is configured to be opened or pivoted outwardly to enable the user to easily remove a completed three-dimensional (3D) printed object from the build platform after the printing process is complete. In one embodiment, the lid 120 may be connected via a hinge mechanism positioned along a rear or lateral edge to provide smooth and stable movement. The transparent material of the lid enables users to monitor the printing process while providing a safety barrier against heat or moving components during operation.

The receptacle bin 109 is positioned at the lower section of the housing 102 and is removably mounted to receive recyclable polymeric waste. The bin 109 may slide outward from the housing for convenient disposal of plastic waste and subsequent cleaning or maintenance.

A battery 604 is disposed within the rear wall 602 of the housing 102 and is configured to supply electrical power to the grinding, melting, extrusion, and 3D printing components of the apparatus. The battery 604 enables the apparatus 100 to operate independently of a constant external power supply, thereby enabling portable or off-grid functionality. The battery 604 may be a lithium-ion or equivalent high-capacity rechargeable cell, equipped with internal protection circuitry for voltage and current regulation.

In the preferred embodiment, the battery 602 also provides power to the electronic control system and the digital control interface 116, providing uninterrupted functionality of the graphical display and status indicators even during portable or battery-only operation.

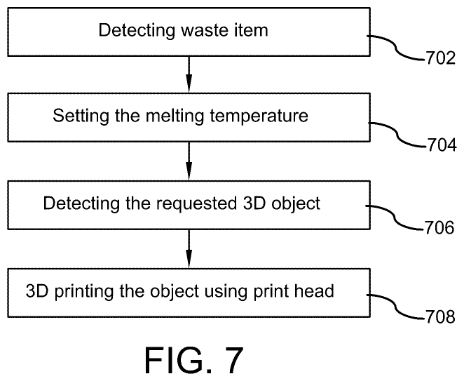

FIG. 7 illustrates another process flow diagram illustrating a method of automated operation of the self-contained recycling and additive manufacturing apparatus of the present invention. Initially, the apparatus 100 performs detection of a waste item (Step 702). In this step, sensors such as optical, infrared, or thermal recognition devices may determine the polymer category (e.g., PET, HDPE, or PP), color, and physical characteristics of the waste item.

Then, the apparatus executes setting of the melting temperature (Step 704). Based on the data acquired from the detection step, an internal controller (not shown) automatically adjusts the appropriate temperature range for the identified polymer. The adaptive control enhances process efficiency and prevents degradation of material properties. For example, PET may be heated to approximately 250° C., while HDPE may require temperatures around 220° C.

Thereafter, the digital control interface receives a command from the user, selecting a design file or preloaded 3D model (Step 706). The system confirms the design parameters, including object dimensions, printing resolution, and filament feed rate. Detection of the requested object can also include file verification or compatibility checks such that the design is suitable for printing with the generated recycled filament.

Finally, the apparatus 100 performs 3D printing of the object using the print head (Step 708). The print head assembly operates within the enclosed printing chamber to deposit recycled filament in successive layers on the build platform, forming the selected 3D object. The printing process is monitored in real-time to maintain optimal extrusion temperature, speed, and layer precision.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “self-contained recycling and additive manufacturing apparatus”, “integrated recycling and additive manufacturing system”, and “apparatus” are interchangeable and refer to the self-contained recycling and additive manufacturing apparatus 100 of the present invention.

Notwithstanding the forgoing, the self-contained recycling and additive manufacturing apparatus 100 of the present invention can be of any suitable configuration as is known in the art without affecting the overall concept of the invention, provided that it accomplishes the above stated objectives. One of ordinary skill in the art will appreciate that the self-contained recycling and additive manufacturing apparatus 100 shown in the FIGS. are for illustrative purposes only, and that many other configurations of the self-contained recycling and additive manufacturing apparatus 100 are well within the scope of the present disclosure. Although the dimensions of the self-contained recycling and additive manufacturing apparatus 100 are important design parameters for user convenience, the self-contained recycling and additive manufacturing apparatus 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject canter. It is, of course, not possible to describe every conceivable combination of components or methodologies for purposes of describing the claimed subject canter, but one of ordinary skill in the art may recognize that many further combinations and permutations of the claimed subject canter are possible. Accordingly, the claimed subject canter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A self-contained recycling and additive manufacturing apparatus comprising:
a housing;
a waste intake and sorting assembly;
a receptacle bin;
a print head;
a grinding and melting subsystem; and
a filament spool;
wherein said waste intake and sorting assembly is configured to receive, sort, and store recyclable polymeric waste materials in said receptacle bin;
wherein said grinding and melting subsystem is operatively connected to said waste intake and sorting assembly and mechanically reduces said recyclable polymeric waste materials into particulate material form and subsequently applies controlled thermal energy to melt said particulate material form into a homogeneous molten polymer;
wherein said housing comprises a control interface section in the form of an interactive display panel and is configured to provide user input, status indication, and operational control of the recycling and additive manufacturing apparatus;
wherein said control interface is operatively connected to an internal electronic controller for controlling mechanical and thermal components of the recycling and additive manufacturing apparatus;
wherein an upper portion of said housing comprises a printing chamber covered by a transparent protective lid;
wherein said printing chamber comprises a movable build platform disposed beneath said print head that is supported by a gantry for controlled three-dimensional motion during additive manufacturing operations;
wherein said filament spool is operatively connected to said grinding and melting subsystem and is supplied from said recyclable polymeric waste materials received by the recycling and additive manufacturing apparatus in the form of thermoplastic filament; and
further wherein said filament spool is positioned within said printing chamber to supply said thermoplastic filament to an extrusion nozzle of said print head.

2. The self-contained recycling and additive manufacturing apparatus of claim 1, wherein said receptacle bin of said waste intake and sorting assembly is removably mounted to said housing and comprises a material selected from the group consisting of a high-density polyethylene (HDPE) and a stainless steel.

3. The self-contained recycling and additive manufacturing apparatus of claim 1, wherein said grinding and melting subsystem comprises a rotary blade assembly driven by an electric motor operating between 3000 rpm and 6000 rpm.

4. The self-contained recycling and additive manufacturing apparatus of claim 1, wherein said waste intake and sorting assembly is configured to receive, identify, and process said recyclable polymeric waste materials before delivery to said grinding and melting subsystem.

5. The self-contained recycling and additive manufacturing apparatus of claim 1, wherein said grinding and melting subsystem comprises a shredder including an electric motor and a grinder to mechanically comminute said recyclable polymeric waste materials.

6. The self-contained recycling and additive manufacturing apparatus of claim 5, wherein said comminuted said recyclable polymeric waste materials are moved toward a separator, further wherein said separator comprises a heater module configured to heat and segregate said comminuted said recyclable polymeric waste materials based on criteria selected from the group consisting of polymer type, polymer color, and polymer density.

7. The self-contained recycling and additive manufacturing apparatus of claim 6, wherein said grinder is configured to mechanically pulverize and reduce a particle size of said comminuted said recyclable polymeric waste materials into ground polymeric flakes for melting.

8. The self-contained recycling and additive manufacturing apparatus of claim 7 further comprising a heater coupled to said grinder and configured to receive said ground polymeric flakes and melt said ground polymeric flakes into a molten polymer, wherein said heater selected from the group consisting of a resistive heating element, an induction heating coil, and an infrared thermal array operating within a temperature range from 180° C. to 260° C.

9. The self-contained recycling and additive manufacturing apparatus of claim 8 further comprising an extruder operatively connected to said heater for receiving said molten polymer and for said thermoplastic filament formation of said molten polymer, wherein said extruder comprises a nozzle, an extrusion die, and a cooling channel configured to form a continuous said thermoplastic filament of consistent diameter.

10. The self-contained recycling and additive manufacturing apparatus of claim 9, wherein said recyclable polymeric waste materials selected from the group consisting of polyethylene terephthalate (PET), high-density polyethylene (HDPE), and polypropylene (PP).

11. A method of recycling and additive manufacturing, the method comprising the steps of:
providing a housing, a waste intake and sorting assembly, a receptacle bin, a print head, a grinding and melting subsystem, and a filament spool;
receiving recyclable polymeric waste materials in said receptacle bin of said waste intake and sorting assembly;
operatively connecting said grinding and melting subsystem to said waste intake and sorting assembly;
mechanically reducing said recyclable polymeric waste materials into particulate material form;
applying controlled thermal energy to melt said particulate material form into a homogeneous molten polymer;
wherein said housing comprises a control interface section in the form of an interactive display panel and is configured to provide user input, status indication, and operational control of the recycling and additive manufacturing apparatus;
operatively connecting said control interface to an internal electronic controller for controlling mechanical and thermal components of the recycling and additive manufacturing apparatus;
wherein an upper portion of said housing comprises a printing chamber covered by a transparent protective lid;
wherein said printing chamber comprises a movable build platform disposed beneath said print head that is supported by a gantry for controlled three-dimensional motion during additive manufacturing operations;
operatively connecting said filament spool to said grinding and melting subsystem;
supplying said filament spool from said recyclable polymeric waste materials received by the recycling and additive manufacturing apparatus in the form of thermoplastic filament;
spooling said filament spool with said thermoplastic filament; and
supplying said thermoplastic filament to an extrusion nozzle of said print head.

12. The method of recycling and additive manufacturing of claim 11, wherein said receptacle bin of said waste intake and sorting assembly is removably mounted to said housing and comprises a material selected from the group consisting of a high-density polyethylene (HDPE) and a stainless steel.

13. The method of recycling and additive manufacturing of claim 11, wherein said waste intake and sorting assembly is configured to receive, identify, and process said recyclable polymeric waste materials before delivery to said grinding and melting subsystem.

14. The method of recycling and additive manufacturing of claim 11, wherein said grinding and melting subsystem comprises a shredder including an electric motor and a grinder to mechanically comminute said recyclable polymeric waste materials.

15. The method of recycling and additive manufacturing of claim 14, wherein said comminuted said recyclable polymeric waste materials are moved toward a separator, further wherein said separator comprises a heater module configured to heat and segregate said comminuted said recyclable polymeric waste materials based on criteria selected from the group consisting of polymer type, polymer color, and polymer density.

16. The method of recycling and additive manufacturing of claim 15, wherein said grinder is configured to mechanically pulverize and reduce a particle size of said comminuted said recyclable polymeric waste materials into ground polymeric flakes for melting.

17. The method of recycling and additive manufacturing of claim 16 further comprising a heater coupled to said grinder and configured to receive said ground polymeric flakes and melt said ground polymeric flakes into a molten polymer, wherein said heater selected from the group consisting of a resistive heating element, an induction heating coil, and an infrared thermal array operating within a temperature range from 180° C. to 260° C.

18. The method of recycling and additive manufacturing of claim 17 further comprising an extruder operatively connected to said heater for receiving said molten polymer and for said thermoplastic filament formation of said molten polymer, wherein said extruder comprises a nozzle, an extrusion die, and a cooling channel configured to form a continuous said thermoplastic filament of consistent diameter.

19. The method of recycling and additive manufacturing of claim 18, wherein said recyclable polymeric waste materials selected from the group consisting of polyethylene terephthalate (PET), high-density polyethylene (HDPE), and polypropylene (PP).

20. A method of recycling and additive manufacturing, the method comprising the steps of:
providing a housing, a waste intake and sorting assembly, a receptacle bin, a print head, a grinding and melting subsystem, and a filament spool;
receiving recyclable polymeric waste materials in said receptacle bin of said waste intake and sorting assembly;
operatively connecting said grinding and melting subsystem to said waste intake and sorting assembly;
mechanically reducing said recyclable polymeric waste materials into particulate material form;
applying controlled thermal energy to melt said particulate material form into a homogeneous molten polymer;
controlling mechanical and thermal components of the recycling and additive manufacturing apparatus;
wherein an upper portion of said housing comprises a printing chamber covered by a transparent protective lid;
wherein said printing chamber comprises a movable build platform disposed beneath said print head that is supported by a gantry for controlled three-dimensional motion during additive manufacturing operations;
operatively connecting said filament spool to said grinding and melting subsystem;
supplying said filament spool from said recyclable polymeric waste materials received by the recycling and additive manufacturing apparatus in the form of thermoplastic filament;
spooling said filament spool with said thermoplastic filament;
supplying said thermoplastic filament to an extrusion nozzle of said print head; and
printing a 3D object with said thermoplastic filament.
